(19) United States
(12) Patent Application Publication
(10) Pub. No.: US 2025/0274155 A1
(43) Pub. Date: Aug. 28, 2025

(54) DOCKING CRADLE AND CHARGING/DATA EXCHANGE DEVICES

(71) Applicant: Steven Jerome Caruso

(72) Inventor: Steven Jerome Caruso

(21) Appl. No.: 18/586,493

(22) Filed: Feb. 25, 2024

(51) Int. Cl. H04B 1/3877; H02J 7/00

(52) U.S. Cl. CPC H04B 1/3877; H02J 7/0044

(57) ABSTRACT

New and novel structures to support a cell phone, a tablet, a PDA, a game system, laptop or other device has been disclosed. Additionally, novel means of charging devices have been disclosed that make it more convenient for the user, protect the devices fragile charging port, and are able to support a wide variety of devices in or out of covers/cases etc.

### REFERENCE TO RELATED APPLICATIONS

This application is a Continuation In Part of and claims the benefit of U.S. application Ser. No. 17/241,652, filed Apr. 27, 2021, which is a Continuation of Ser. No. 16/430,386, filed Jun. 3, 2019, now U.S. Pat. No. 11,019,974, which is a Continuation of Ser. No. 15/680,078, filed Aug. 17, 2017, now U.S. Pat. No. 10,357,138, which is a Continuation of Ser. No. 14/536,663, filed Nov. 9, 2014, now U.S. Pat. No. 9,814,364 which claims priority from provisional application No. 61/982,845 filed Apr. 22, 2014, and also claims priority from provisional application No. 61/902,285 filed Nov. 10, 2013. This application is also is a Continuation In Part of and claims the benefit of U.S. application Ser. No. 17/392,993, filed Aug. 3, 2021 which claims priority from provisional application No. 63/173,467 filed Apr. 11, 2021, and also claims priority from provisional application No. 63/061,119 filed Aug. 4, 2020. The entire disclosures of the above, and each application referred to in this paragraph of listed patent applications and their entire prosecution history to date is and are hereby incorporated herein by reference in their entirety.

### BACKGROUND OF THE INVENTION

The present invention relates generally to New and novel structures to support a cell phone, a tablet, a PDA, a laptop, a game system or other device has been disclosed. Additionally, novel means of charging and data transfer of devices have been disclosed.

### BRIEF SUMMARY OF THE INVENTION

The present invention relates generally to New and novel structures to support a cell phone, a tablet, a PDA, a laptop computer, a game system or other device(s). Additionally, the batteries of these devices may be charged as well as data exchanged is in a novel way through the use of this invention.

An important feature of some of the embodiments is the ability to accommodate different sizes of electronics by the structure incorporating adjustable holding elements while maintaining automatic docking and alignment features.

### BRIEF DESCRIPTION OF SEVERAL VIEWS OF THE DRAWINGS

FIG. 1—is a trimetric view of an embodiment of the invention.

FIG. 2—is a trimetric view of another embodiment of the invention.

FIGS. 3A-3E is a details of structures and methods of holding plugs.

FIG. 4—is a front plan front view of an embodiment of the invention.

FIG. 5—plan front view nearly identical to FIG. 1 but shown supporting a sample users electronic device 11, and the “V“ed” retention walls 2, have been pivoted to be generally vertical by electronic device 11.

FIG. 6 is a side view of the invention.

FIG. 7 is a top view of the invention.

FIG. 8 is substantially the same as FIG. 7, however the adjustable over cap, 19, that has a “L” leg 20 is not present.

FIG. 9 is a trimetric view of the invention.

FIG. 10 is a trimetric view of an over center style toggle locking device

FIG. 11 is a top view of another embodiment of a docking device

FIG. 12 is a front view of the device of FIG. 11

FIG. 13 is a side view of the device of FIG. 11

FIG. 14 is a trimetric
of the device of FIG. 11

FIG. 15 is a trimetric of the device of FIG. 11 showing greater detail of the plug box/hasp in an open position.

FIG. 16 is a trimetric of the device of FIG. 11 and of an electronic device such as a laptop in an about to be docked position.

FIG. 17 is a trimetric of the device of FIG. 15 and the electronic device such as a laptop in a docked position.

### REFERENCE CHARACTERS USED

The following reference characters are used in the drawings of refer to the parts of the present invention. Like reference characters indicate like or corresponding parts in the respective views.
1—Base structure—can take many forms
2—Adjustable retention wall, guide, or clip or rib
3—Charging Plug adjustable support structure
4—Charging Plug receptacle/clamp and/or clamp liner
5—Adjustment slot(s)
6—Adjustment slot(s)
7—Adjustment slots(s)
8—Adjustable/adjustment retention wall or clip
9—Motor—not shown
10—Charging/electrical/data Plug
10.5 Another Charging/electrical/data Plug
11—Electronic device, cell phone, pda, game device, laptop, tablet etc.
12—Device ejection lever—
13—Pivot of 2—Adjustable retention wall, guide or clip A2
14—Pivot of 12—Device ejection lever
15—Adjustable trunnion part of 4—electrical charging Plug receptacle/clamp
16—Locking thumbscrews/snaps/toggle clamps or other retention structure(s)
17—Retention wall, guide or clip
18—Ejection pin-wall or similar structure
19—Overcap with “L” leg—provides a way to accommodate various thickness (top view/side view of device+ case), and restrict movement by virtue of the L.
20—“L” leg structure can be part of 19 or 2.
21—lower finger structure for pinching with 12, to eject inserted electronic device 11. 21 is fixed to device or movable/adjustable on trunnion 15
22—pivot
23—pivot
24—slot
25—locking screw/cam of 4
26 hinge of 4
27—spur gear
28—rack
29—rack
30—Electrical and/or data cord/cable
31—Movable side
32—Movable side
33—Charging/electrical/data Port(s)
34—Total plug holding assembly
35—Another plug holding structure
36—pivot arm/link.
37—Configurations and/or resilient, conformable material to hold plug 10

### DETAILED DESCRIPTION OF THE INVENTION

While the invention will be described in connection with several preferred embodiments, it will be understood that the invention is not limited to these embodiments. On the contrary, the invention includes all alternatives, modifications, combinations, and equivalents as may be included within the spirit and scope of the appended claims. The present invention relates generally to New and novel structures to support a cell phone, a tablet, a PDA, a game system or other device. Additionally, the batteries of these devices may be charged as well as data exchanged in a novel way through the use of this invention.

An important feature of some of the embodiments is the ability to accommodate different sizes of electronics by the structure incorporating adjustable holding elements. There have been numerous attempts to hold these electronic devices and there have been numerous attempts to create charging systems. The problems with these past attempts are as follows: cradles are often very specific to the type/brand of device being held. Furthermore, if the user puts their own case, cover etc. the cradle often no longer fits. If the cradle is designed to accommodate these changes, it is an “open” stand, that really does not hold, but only props. Similar problems exist with charging cradles. Aftermarket cases are not accommodated. Some chargers actually dictate/require the user to use their case for the device to work. In the case of no cradle/dock, the user has to fumble with the plug and socket every time for a charge, and the connectors are getting smaller and smaller. Additionally, this “fumbling” puts undue stress and wear on the components. These charging stations include their own transformer, which is often of inferior quality and adds cost to the charging cradle/dock. This invention surmounts these shortcomings.

A charging dock is disclosed that has adjustable holding elements. These may slide and/or pivot etc. and are lockable into a position. In this way they may accommodate various devices, and those devices regardless of the covers/cases they may have. There may also be an adjustable provision for holding the charging plug. This plug could be from the charger the consumer already has thus saving cost. It is adjustable to accommodate the various locations where the charging port may be on the device to be charged. It is also adjustable to clamp the various electrical plugs that are out there.

Additionally, the adjustable unit can be configured as a mounting system that can then be utilized in further mounted to another mounting interface such as a cylindrical shape that would fit in a cars cup holder, or a clock or clock radio or a lamp, or a wearable sports pocket for jogging walking etc., or a suction cup mount for various applications or a clamp for use on a bicycle motorcycle or other vehicle or a bed tray, etc. Additionally, the units may be nested one in front of the other to create multiple charging stations for multiple devices simultaneously.

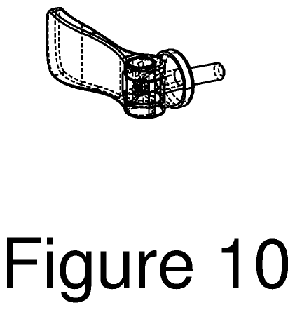

All of these, adjustments may be made with thumbscrews 16, or quick cam action clamps, not directly shown, but an exemplary disclosure is depicted separately in FIG. 10. Also of note is an electrical connection is not a necessity for all embodiments. As such, the device may be used to automatically align, for example, wireless charging or data interfaces such as induction. One such interface is known as Qi technology. This optimization of relative location repeatability between a users device and an induction source is even more critical and necessary when users employ a wide range of various cases of varying thickness and features. Additionally, it is anticipated that this invention is versatile in structural enablement allowing it to work with USB plugs, micro USB plugs, USB-C plugs, RCA plugs, phono plugs, and a wide variety of other types of charging and or data oriented plug styles.

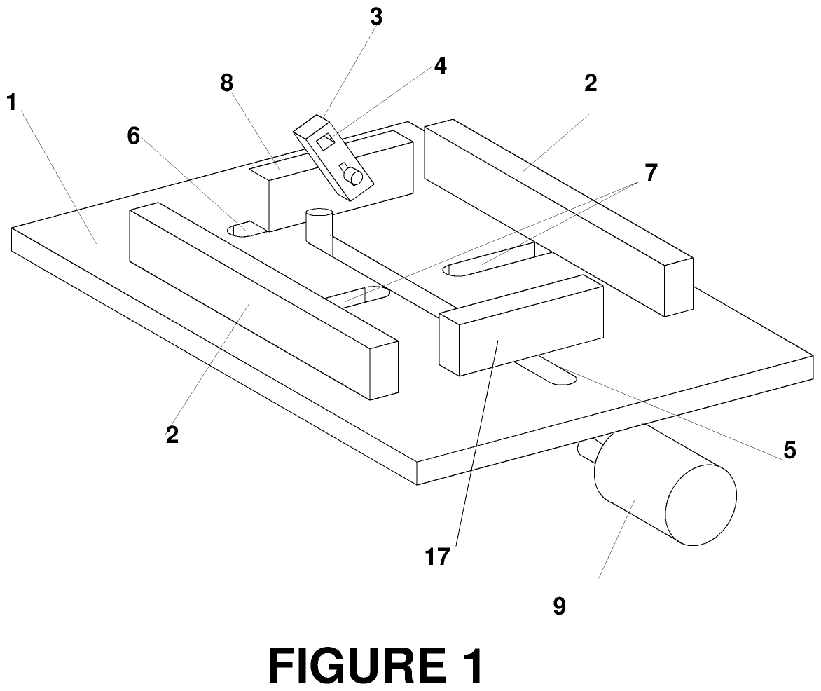

So now referring to FIG. 1, a trimetric of one such adjustable dock can be seen. 1—Base structure is the main part of the inventive structure. It contains 5, and 6—Adjustment slot(s), although other suitable structures such as ribs could be substituted for 8—Adjustable retention wall or clip 2 is movable/adjustable on the base structure 1. 3—Charging Plug adjustable support structure can also be seen to be movable and adjustable via 3—Charging Plug adjustable support structure and 8—Adjustable retention wall or clip. 9—Motor can optionally drive 17—Retention wall or clip via slot 5, or other suitable structure such as ribs/dovetails etc. towards 4 charging plug receptacle and the plug-jack it is to hold.

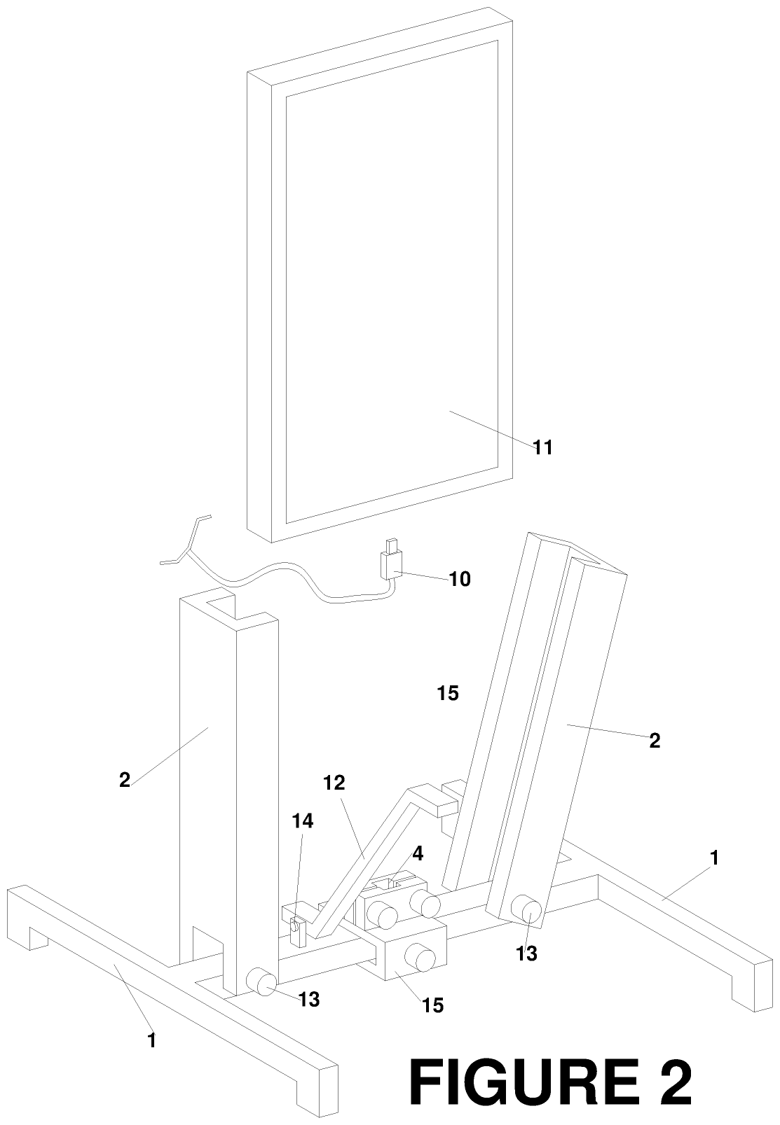

A sample initial set could proceed as follows: the user would plug their phone, or other device in, into its wall adapter in the usual non-dock cradle manner then set their phone into this inventive cradle dock. Then adjust all the clamping members around the device and onto the plug. The clamping members may be held in place by thumb screws, detents, snaps, double sided tape, or other adjustable fastening means. In this embodiment a motor 9 is optionally employed for “robotic” docking. So the motor would be in a final position for set up. Once set up has occurred, the motor can undock and deliver the phone unplugged by pulling the phone or device via 18—Ejection pin-wall or similar structure. Similarly, when the phone/device is to be charged/when the user wants to charge again, they simply place their device down, and the motor 9 moves it into a charging plugged in position by driving 17—Retention wall or clip towards the charging jack holder 4. Motor can be activated by appropriate switches, the docking action could be initiated by a switch activated through the act of placing the phone/device into the cradle. Additionally, the holding elements may be configured in a “V” or funneling shape, so that the device is progressively held tighter as the unit is seated/motored into its charging/holding position. This is more clearly illustrated in FIG. 2.

Referring to FIG. 2, a similar structure is disclosed with many differences. The unit is more or less vertically oriented so that gravity is used as a helper to seat the device to be charged. As before, the holding elements may be configured in a “V” or funneling shape, so that the device is progressively held tighter as the unit is seated into its charging/holding position. Also as before, a motor may be integrated to assist in the docking and undocking. Additionally, there may be a lever for unseating the device when the user is ready to grab and go. It should be noted that this lever could have bee incorporated into the embodiment of FIG. 1. As a matter of fact all features of all embodiments may be shared substituted etc. yielding additional variations. Referring back to FIG. 2, adjustable retention wall or clips, 2, can be seen. In this embodiment these walls or clips are formed as channels. These channels are preferably adjustable (not depicted) as far as the thickness of the device to be accommodated, though this is not a necessity of the invention. These channels are adjustable to the base 1 via 13 of 2, the Adjustable retention wall or clip. Here too thumbscrews snaps tape or the like can be employed. 4, accepts plug 10, and like the other embodiments is adjustable, in this case via 15 in two axis to allow for the various positions that the jack-receptacle could end up in. Optionally, in all embodiments the jack and/or charger may be provided by the end user, or be built in as a part(s) of the device disclosed. As before, a motor can be used. Or gravity and optionally an ejection lever 12 can be used to gently and accurately disseat the device from its charging jack.

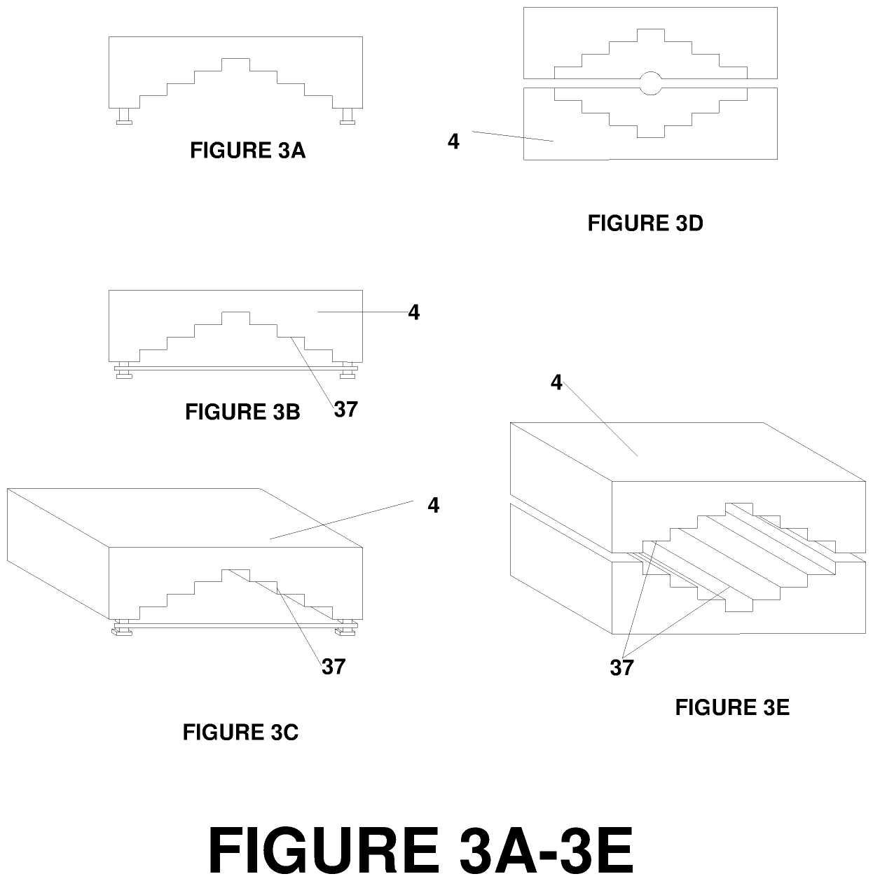

FIGS. 3A-3E shows how a stepped block interface(s) may be used for holding charging plugs of different sizes and shapes. These views show how a plug receptacle may be shaped and/or lined with a shaped and/or resilient material to accommodate a wide range of plug shapes and sizes. These may be configured as two sides which may have configurations and/or lined with resilient material on one side, as depicted in FIGS. 3A, 3B and 3C, or may have configurations and/or lined with resilient material both sides of the clamping/holding faces such as is depicted in FIGS. 3D and 3E. The plug may be inserted, or clamped between a hinged interface detailed later and held (via thumbscrews/toggles snaps or the like) to create a structurally robust attachment and location for the plug(s). These configurations may selectively be used in any of the disclosed plug holding assemblies such as 34, as well as 35 in addition to others.

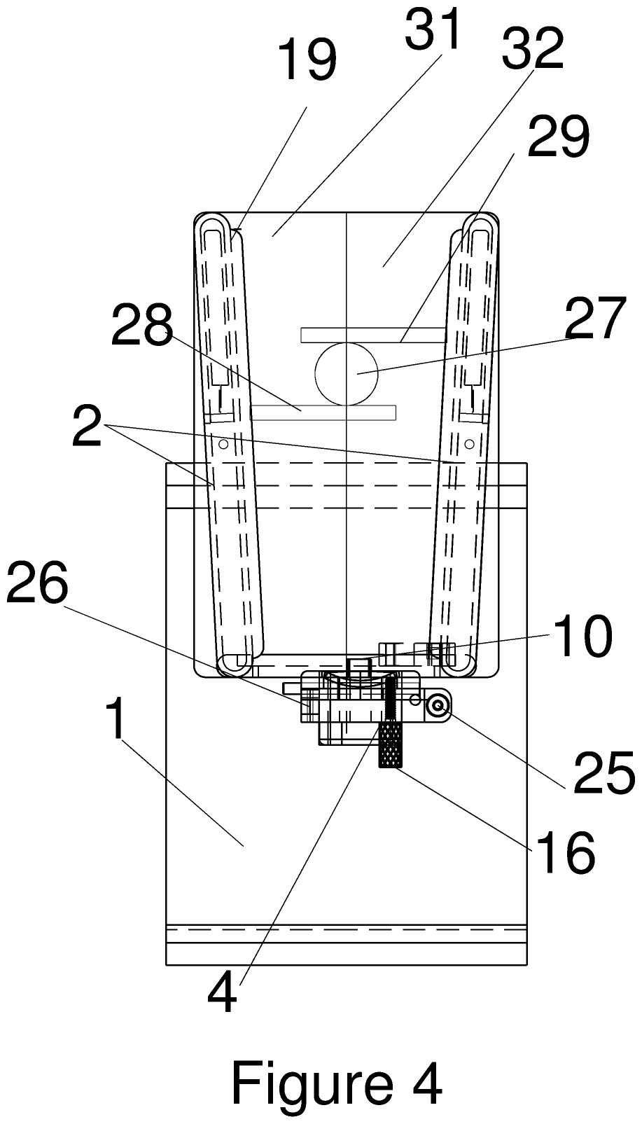

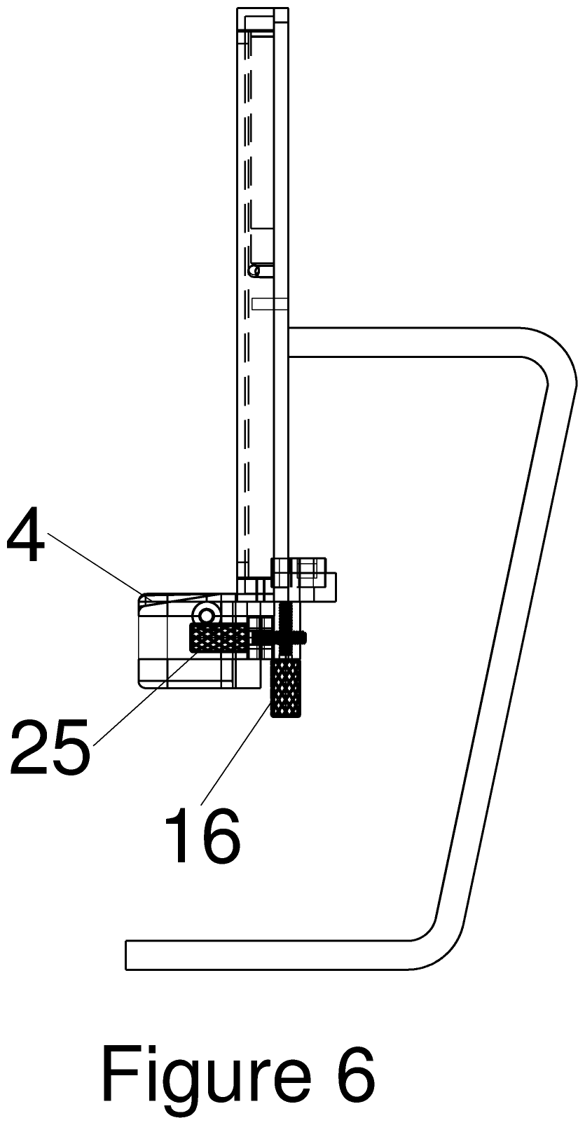

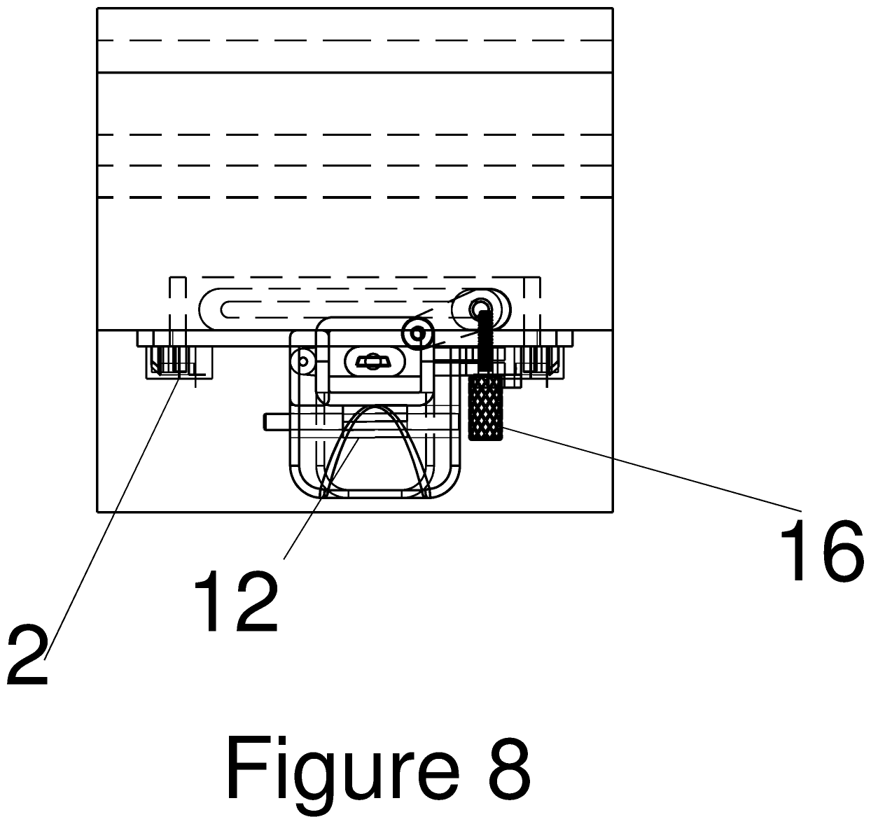

Referring now to embodiments of FIGS. 4 through 9, it can be seen that the holding elements 2, may be optionally angled relative to each other to provide a V-shaped entry. This facilitates easier loading of the device to be held as the user just has to be generally be close with sliding it and the device is guided to final position.

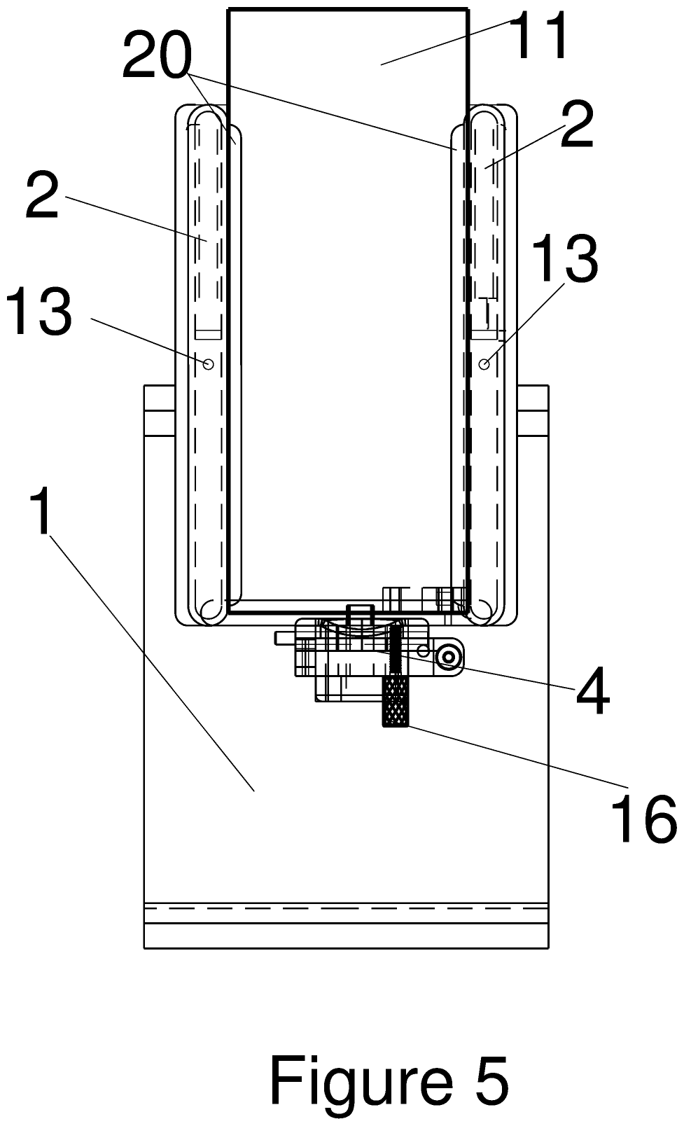

Referring specifically to FIG. 5, this “V” entry track may be optionally spring-loaded, and thus assume a non-V-shape once the item to be held and is secured, and optionally electrically connected is fully slid in. FIG. 5 shows this as retention bars 2, are spring-loaded to pivot about 13 so that the guiding is as previously described with a V-shaped entry yet once the device is completely in it is completely secured. The multi axis funnel provides “drop and connect” convenience.

These sidewalls/retention bars 2, may be lined with a resilient grip material that may be a elastic deformable to prevent the shifting of the item to be held even in cases such as a moving vehicle or bicycle, motorcycle etc.

Additionally, referring to FIG. 4, the movement of these sidewalls 2, may be synchronized via a gear wheel 27 attached to a non moving member such as a plate attached to base structure 1, and racks 28 and 29 may be attached to each of the retention bars 2 or their respective backing plates/movable sides 31/32, and the left bar, and or plate may have its rack on top in the right bar/and or plate would have its rack on the bottom of the gear wheel or visa versa. In this way both sidewalls may move toward or apart each other in a synchronized way with each other. Additionally both or all may be optionally locked with a single thumbscrew or quick cam action clamp. As everything is drivingly interconnected, this locking force can be applied to either of the bars, backing plate(s) or the interconnecting spur gear wheel.

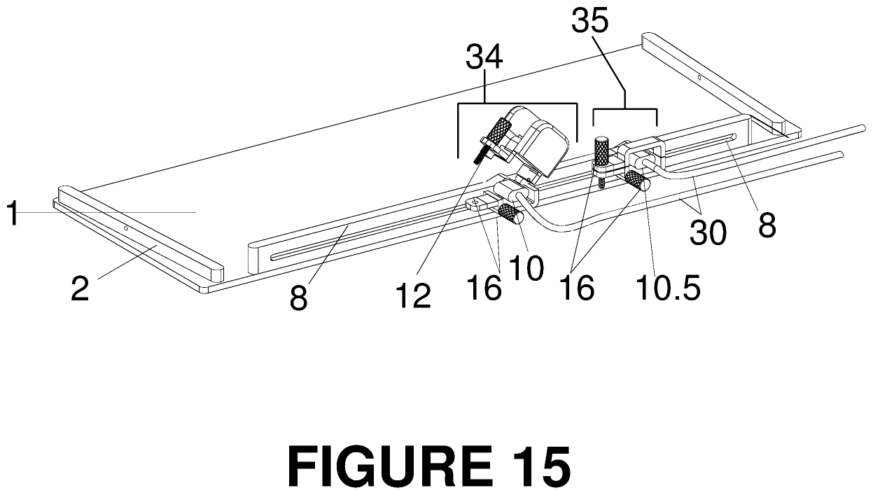

The charging plug receptacle/clamp 4, may take the form of a hinged box or hasp. Referring to figures one and four, and FIG. 15, a hinge 26 can be seen, which is held closed by thumb screw 25. In this way receptacle/clamp 4 may be lined with foam, or springs or molded in springs or those self adjusting features outlined with respect to FIGS. 3A-3E, and thus close around various size plugs 10, and adjustably hold them appropriately. A quick release for the plug (with or without the clamp), is also structurally featured in selected embodiments so that the plug may be made accessible so that it may be used (if only temporarily) with another device without having to “dock” the other device.

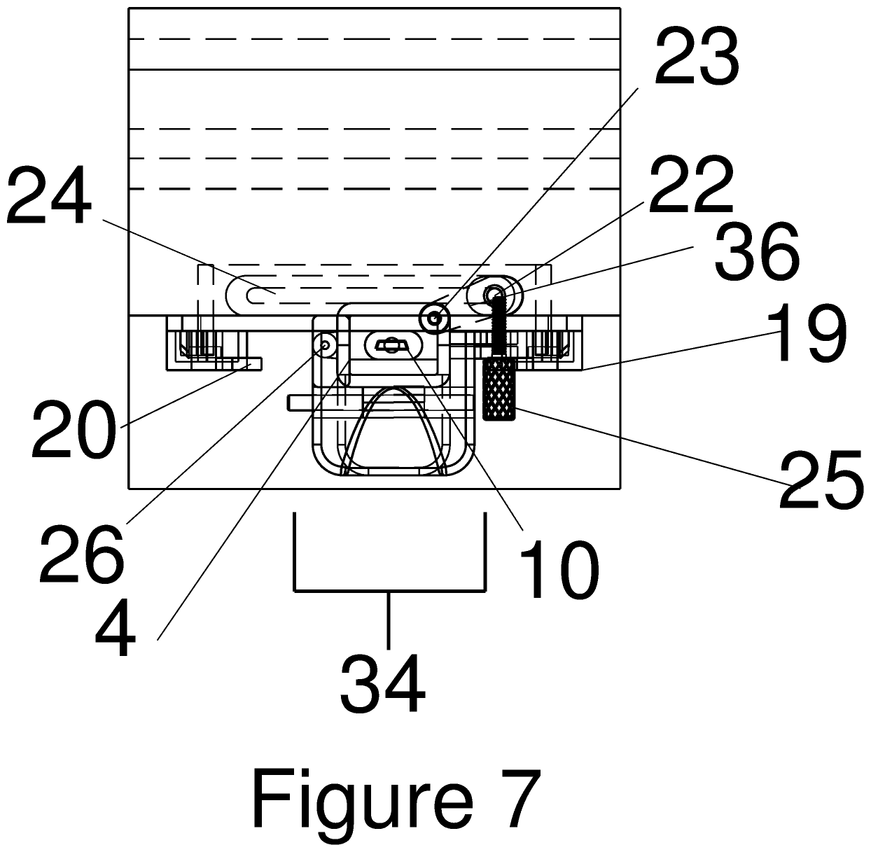

Referring now to FIG. 7, it can be seen that the clamp 4, for holding the electrical plug 10, is mounted so that it has pivots 22 and 23. Additionally, pivot arm 36, is a slidable in slot 24. These pivots, 22 and 23, as well as the sliding in slot 24, are all lockable via thumbscrews, or cam action over center locks, or other some other locking feature. In this way the plug holding clamp total assembly 34, can traverse and be selectively lockable in multiple axes to accommodate the various places as well as angles a plug may occur in various devices as well as when these various devices have cases, wallets (often uneven), etc. put on them. And so again, referencing all the relevant figures embodiments that include multi-axis linkage for moving the electrical/data continuity plug relative to the electronic devices jack are illustrated and disclosed.

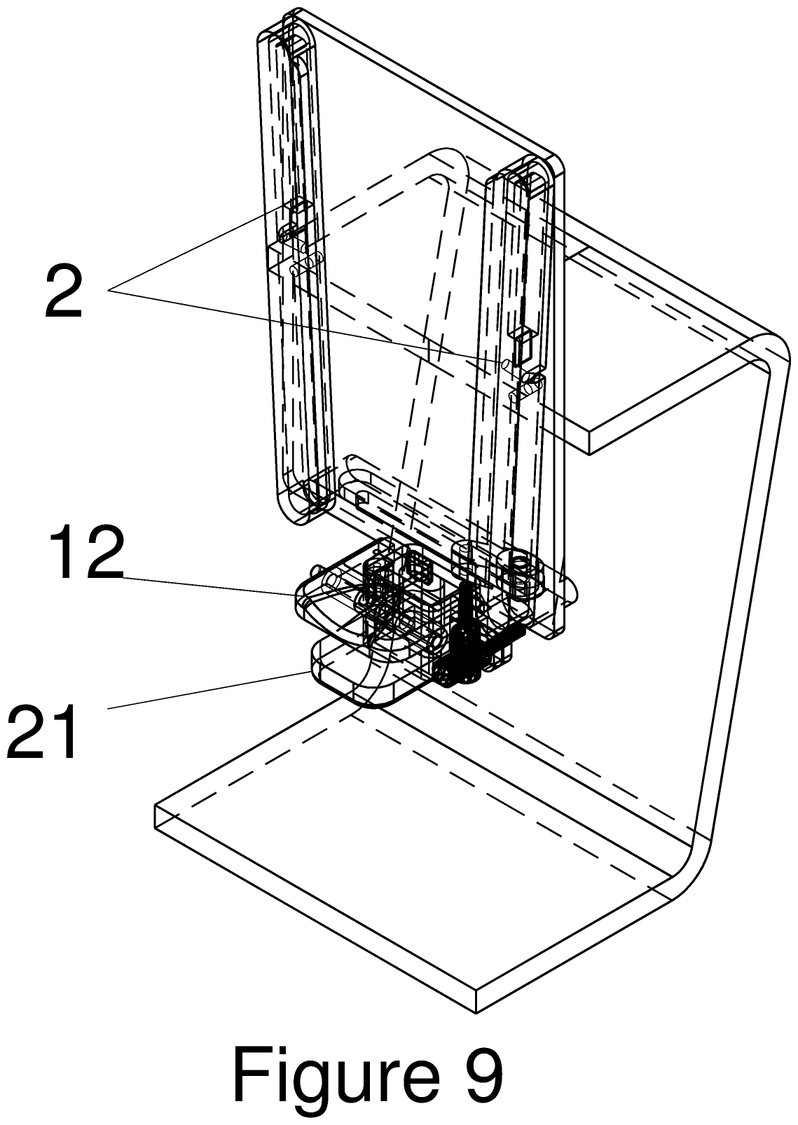

Referring to FIG. 9 it can be seen that the ejection lever 12, and the finger rest 21 creates a dynamic pinch area so that the forces of ejection are mostly within the user's hands and directly between the lower finger rest 21 and the device to be ejected.

Additionally The device ejection lever 12 may be (as depicted) a part of the movable aspect or trunnion so that is always in an optimized position where there is greatest resistance/i.e. the electrical plug.

Also of note is that The product is designed so that the ejection force if the user does not use pinch point pinch area, 21, the force on the ejection lever is still downward towards the other supporting surface of the device. This is an important aspect, as if the electronic device that is being held were just grasped and lifted out of this cradle, the frictional forces of the electrical continuity plug in Jack are enough to lift the entire unit, i.e. the device and the cradle from its supporting surface.

Referring now to FIGS. 4 through 9, an overcap 19—with “L” leg can be seen. This overcap provides a way to accommodate various thickness (top view/side view of device+ case), and restrict movement by virtue of the L. 20 The movements of this over cap and retaining “L” is generally toward and away from backing plate(s) 22. These over caps may be secured frictionally, or with cams, or screws/thumbscrews etc.

When this over cap is not used this “L” leg structure 20 can optionally be part of 2/Adjustable retention wall or clip.

Also a motor (not depicted in these figures) can optionally drive the phone towards the charging plug receptacle and the plug-jack it is to hold and/or optionally de-mount/plug the device.

And so, as before, a sample initial set could proceed as follows: the user would plug their phone, or other device into its wall adapter in the usual non-dock cradle manner then set their phone into this inventive cradle dock. Then adjust all the clamping members around the device and any case or wallet that may hold it, and onto the plug. As stated all these clamping members may be held in place by thumb screws, cam locks, detents, snaps, double sided tape, or other adjustable fastening means. Once set up has occurred, the device is ready to be removed, and when it is subsequently replaced, everything lines up and charging/data exchange etc. may occur with minimal user effort.

Referring now to FIG. 10 a trimetric view of a toggle style locking device can be seen. This is to structurally show, as has already been outlined, that in one or more of the depictions and embodiments showing screws, or thumbscrews, a toggle as well as snaps type features, hook and loop type fasteners, rubber banding etc. or other fastening system is anticipated.

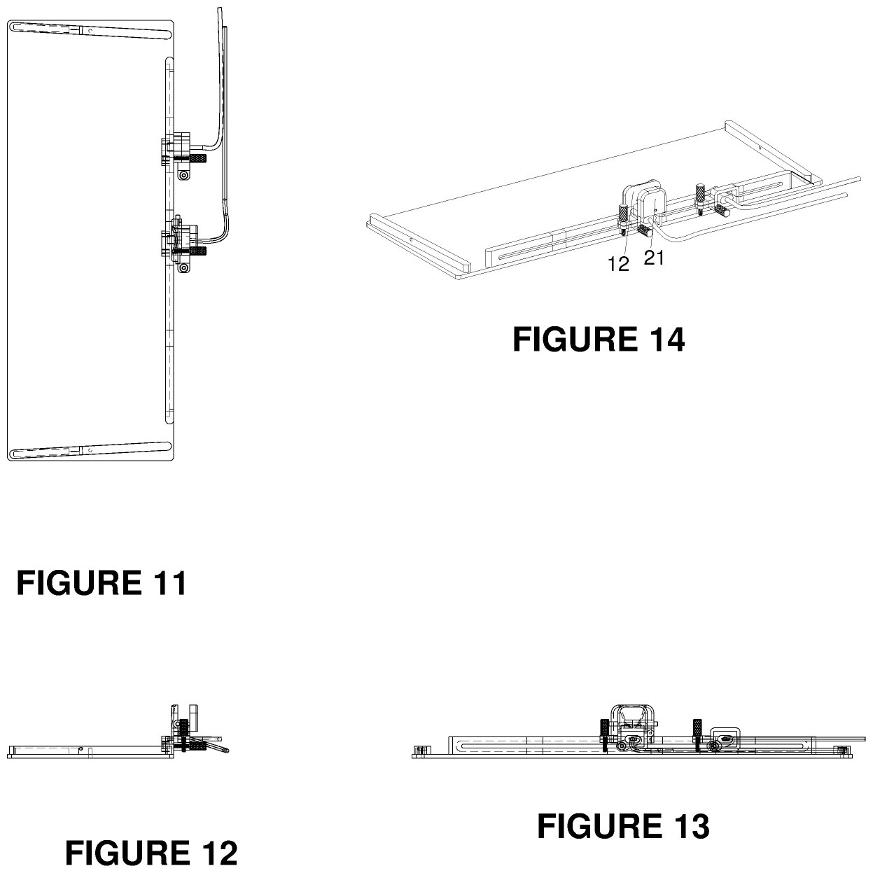

Referring now to FIGS. 11-17 another embodiment of an advanced docking system may be seen.

FIG. 11 is a top view of another embodiment of a docking device and FIG. 12 is a front view of the device of FIG. 11, and FIG. 13 is a side view of the device of FIG. 11 and FIG. 14 is a trimetric view of the device of FIG. 11. These figures show a relatively horizontal adjustable docking station that may accommodate a wide variety of devices from phones, to tablets, to game systems, to laptops as well as others. These figures are to be used in reference to FIGS. 15-17.

FIG. 15 is a trimetric view of the device of FIG. 14 but showing a plug-box/total plug holding assembly 34, or hasp in an opened state to allow a plug to be selectively clamped. Such a structure may be configured or lined with structural features described with reference to FIGS. 3A-3E that details of structures and methods of holding plugs. Such features or lining of the box/hasp may be elastomeric to as well to conform to and grip the various shapes of plugs. FIG. 15 also shows that more than one structural assembly of a plug-box/total Referring to FIG. 15 it can be seen that the ejection lever 12, and the finger rest 21 creates a dynamic pinch area so that the forces of ejection are mostly within the user's hands and directly between the lower finger rest 21 and the device to be ejected.

Additionally The device ejection lever 12 may be (as depicted) a part of the movable aspect or trunnion so that is always in an optimized position where there is greatest resistance/i.e. the electrical plug.plug holding is anticipated and is depicted by contrasting structural assembly 35.

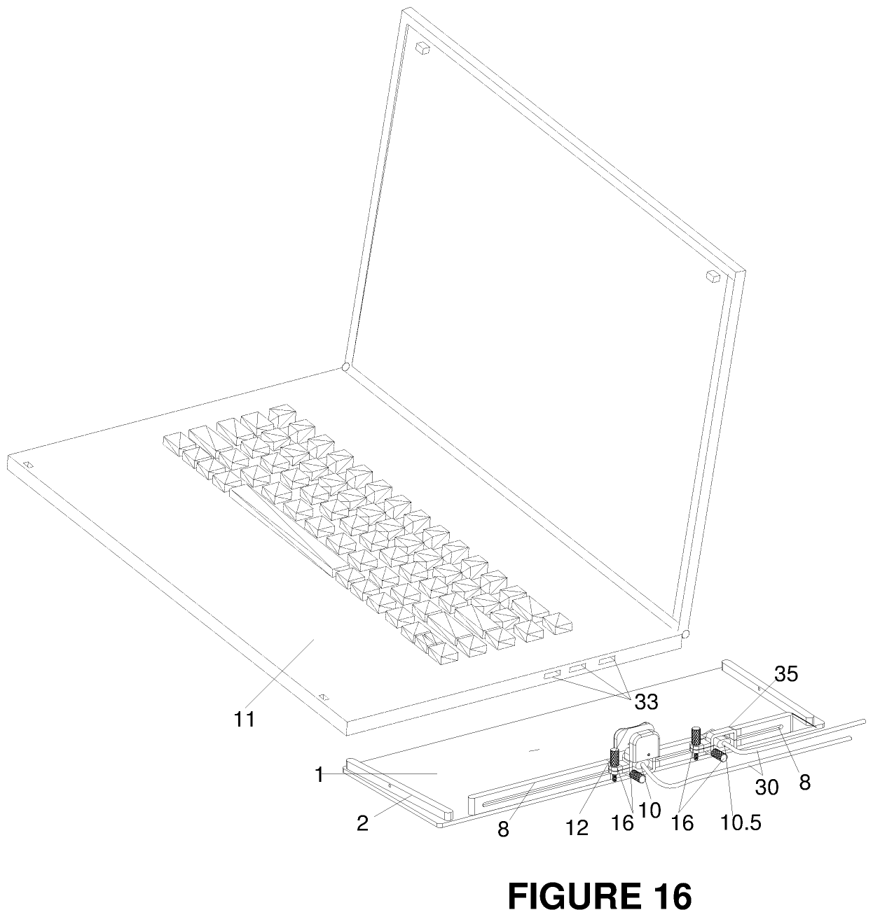

FIG. 16 is a trimetric of the device of FIG. 15 and of an electronic device such as a laptop in an about to be docked position.

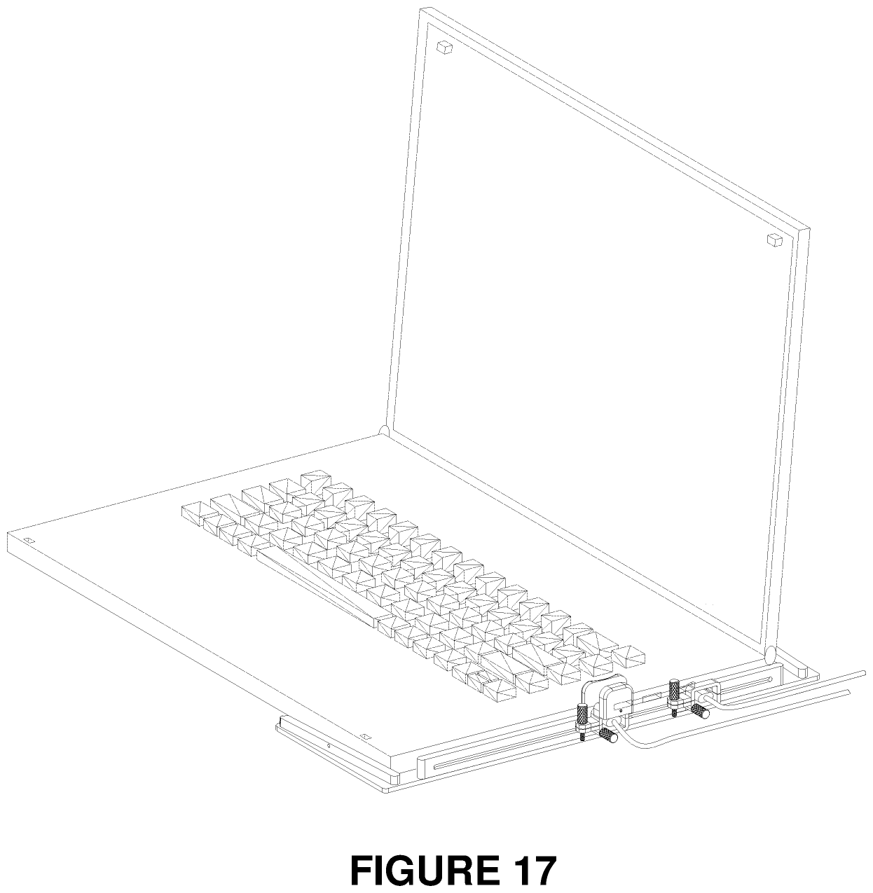

FIG. 17 is a trimetric of the device of FIG. 15 and the electronic device such as a laptop in a docked position. These figures serve to further illustrate the functional utility and novelty of the disclosed structures.

I claim:

1. A device for holding an electrical device comprising;
a. a base structure,
b. a first side rib structure associated with said base structure,
c. a second side rib structure also associated with said base structure,
d. where at least one of said first and second side ribs are adjustable and lockable relative to one other,
e. and a electrical plug clamp which is adjustable in position relative to said at least one adjustable side rib structures, where devices of varying sizes with electrical receptacles in various positions may be accommodated.

2. A device for holding an electronic device comprising;
a. a base structure,
b. at least a first side rib structure associated with said base structure,
c. an electrical plug clamp,
d. where said electrical plug clamp is adjustable and lockable in a position relative to said at least one rib structure,
e. so said electronic devices of varying sizes with electrical receptacles in various positions may be accommodated.

3. A method for holding an electrical device comprising;
a. utilizing a device with at least a first rib structure,
b. aligning a separate electronic device with said rib structure,
c. adjusting an electrical plug clamp which is associated with said rib structure and adjustable in position relative to said electronic device,
d. and locking said plug clamp into a fixed position.
